(19) United States
(12) Patent Application Publication
(10) Pub. No.: US 2019/0338846 A1
(43) Pub. Date: Nov. 7, 2019

(54) DRIVELINE POWER TRANSMITTING COMPONENT WITH LUBRICATION AERATION FOR REDUCED DRAG LOSSES

(71) Applicant: American Axle & Manufacturing, Inc., Detroit, MI (US)

(72) Inventor: Ryan ETTENHOFER, Detroit, MI (US)

(21) Appl. No.: 15/970,359

(22) Filed: May 3, 2018

(51) Int. Cl. F16H 57/04; F16H 57/027; F16N 39/00

(52) U.S. Cl. CPC F16H 57/0483; F16H 57/027; F16H 2700/00; F16N 39/00; F16N 2210/12; F16H 57/0409

(57) ABSTRACT

A vehicle driveline component includes a housing defining an oil sump and a gear rotatably supported within the housing and at least partially in the oil sump. An oil aerating system is provided for introducing air bubbles into the oil sump through an air introduction passage. The air bubbles are directed at the ring gear and will reduce the effective density/viscosity of the oil, thereby reducing drag on the ring gear.

### FIELD

The present disclosure relates to driveline power transmitting components and more particularly to a driveline power transmitting component with lubrication aeration for reduced drag losses.

### BACKGROUND

This section provides background information related to the present disclosure which is not necessarily prior art.

Numerous driveline power transmitting components are provided with oil within the housing and through which driveline components are rotatably supported. The oil is necessary for proper lubrication and cooling of the driveline components. Some driveline components use splash lubrication to lubricate the various components. As the driveline components such as gears are driven through the oil, the oil causes drag/churning forces on the components. Accordingly, it is desirable to reduce the drag/churning forces on the driveline components.

### SUMMARY

This section provides a general summary of the disclosure, and is not a comprehensive disclosure of its full scope or all of its features.

A vehicle driveline component includes a housing defining an oil sump and a gear rotatably supported within the housing and at least partially in the oil sump. An oil aerating system is provided for introducing air bubbles into the oil sump through an air introduction passage. The air bubbles are directed at the ring gear and will reduce the effective density/viscosity of the oil, thereby reducing drag on the ring gear.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic cross-sectional view of a driveline component having an oil aeration system according to the principles of the present disclosure; and

FIG. 2 is a schematic end view of a driveline component having an oil aeration system according to the principles of the present disclosure.

Corresponding reference numerals indicate corresponding parts throughout the several views of the drawings.

### DETAILED DESCRIPTION

Examples will now be described more fully with reference to the accompanying drawings.

Examples are provided so that this disclosure will be thorough, and will fully convey the scope to those who are skilled in the art. Numerous specific details are set forth such as examples of specific components, devices, and methods, to provide a thorough understanding of the present disclosure. It will be apparent to those skilled in the art that specific details need not be employed, that examples may be embodied in many different forms and that neither should be construed to limit the scope of the disclosure. In some examples, well-known processes, well-known device structures, and well-known technologies are not described in detail.

The terminology used herein is for the purpose of describing particular examples only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

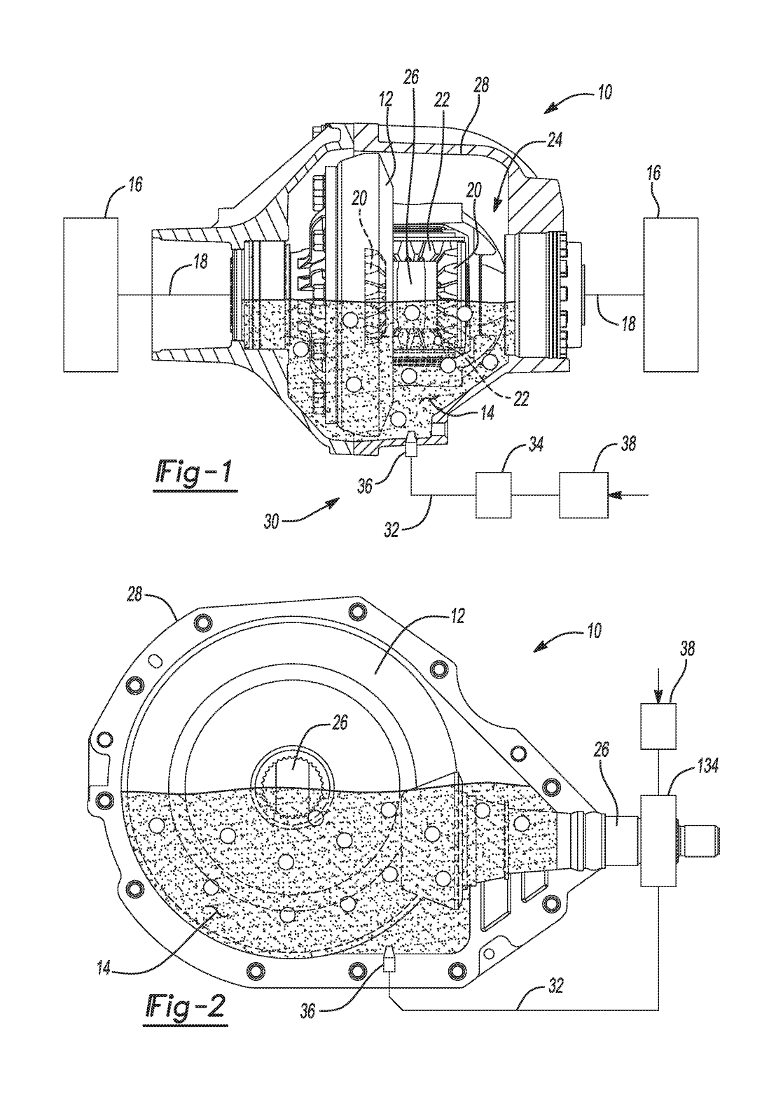

With reference to FIGS. 1 and 2, a vehicle driveline component 10 is schematically shown having a ring gear 12 that is at least partially disposed within a lubricating oil sump 14. As shown, the vehicle driveline component 10 is a differential that lays between two driving wheels 16 that are driven by a pair of half shafts 18. As is well known in the art, the half shafts 18 are driven by a pair of sun gears 20 which are engaged by planet pinions 22. The planet pinions 22 are supported for rotation with the ring gear 12 by a differential case 24. The ring gear 12 is driven by a pinion shaft 26. The planet pinions 22 impart drive rotation from the ring gear 12 to the sun gears 20 which drive the half shafts 18. The sun gears 20 on the half shafts 18 are connected by the free-wheeling planet pinions 22. When traveling straight, the planet pinions 22 do not spin and drive both of the half shafts 18 at the same speed. As the vehicle corners, the planet pinions 22 do spin driving the sun gears 20 and half shafts 18 at different speeds. Although a hypoid ring gear is shown attached to a differential, other forms of ring and pinion gear sets can also be utilized including those that include spiral bevel ring and pinion gears, parallel axis gear sets, and those that employ spindle type torque transferring devices with no differential.

The vehicle driveline component 10 includes a housing 28 in which the ring gear 12, the oil sump 14 and other drive members 20, 22, 24 are disposed. In order to reduce the drag/turning forces on the ring gear 12 and differential case 24, an oil aeration system 30 is provided for introducing air bubbles into the oil sump 14 through an air introduction passage 32. The oil aeration system 30 can include an air pump 34 that introduces air into the air introduction passage 32. One or more nozzles 36 can be provided at an end of the air introduction passage 32 in order to direct air bubbles toward the ring gear 12. The air bubbles are directed at the ring gear 12 and will reduce the effective density/viscosity of the oil, thereby reducing drag losses on the ring gear 12.

The oil aeration system 30 can include an air filtration device 38 to prevent water and debris from being introduced into the housing 24 along with the air bubbles. Alternatively, the existing air within the housing 24 can be pumped to create the air bubbles in order to prevent exterior debris and moisture from being introduced into the housing 24. Accordingly, the air pump 34 can be disposed inside or exterior to the housing 24. The air pump 34 can be driven in various alternative ways. In particular, the air pump 34 can be an electric motor driven air pump 34 (as shown in FIG. 1) or an air pump 134 driven by a drive member of the driveline component such as the pinion/drive shaft 26 that drives the ring gear 12, as shown in FIG. 2.

Although FIGS. 1 and 2 show a vehicle driveline component 10 in the form of a differential, the use of the oil aeration system 30 according to the principles the present disclosure can be utilized with other forms of vehicle driveline components that utilize splash lubrication for transmitting lubricating fluid to elements of the vehicle driveline component. For example, a transfer case can have a sprocket that can be partially or fully submerged in the oil in the sump of the transfer case housing. By way of non-limiting example, still further vehicle driveline torque transferring systems can include independent rear drive axle systems, front and rear beam axle systems, integrated oil pan axle systems (IOPs), transaxles and power transfer units (PTUs).

The air introduction passage 32 can include a one-way valve to prevent oil flow from the sump and up the passage 32.

Although it is intended that anti-foaming agents within the lubricating oil will adequately prevent or control the formation of foam within the oil sump, other measures can be incorporated including the control and deactivation of the air pump when oil foam is detected or shutting off the air pump when the vehicle is operated above a predetermined speed.

The foregoing description has been provided for purposes of illustration and description. It is not intended to be exhaustive or to limit the disclosure. The same may also be varied in many ways. Such variations are not to be regarded as a departure from the disclosure, and all such modifications are intended to be included within the scope of the disclosure.

What is claimed is:

1. A vehicle driveline component, comprising;
a housing defining an oil sump;
a gear rotatably supported within the housing and at least partially in the oil sump; and
an air pump connected to an air introduction passage for introducing air bubbles into the oil sump.

2. The vehicle driveline component according to claim 1, further comprising a nozzle connected to the air introduction passage and directed toward the gear.

3. The vehicle driveline component according to claim 2, wherein the air pump is driven by a drive component of the vehicle driveline.

4. The vehicle driveline component according to claim 1, wherein the gear is a ring gear of a differential.

5. The vehicle driveline component according to claim 4, wherein the ring gear is driven by a drive shaft.

6. The vehicle driveline component according to claim 1, wherein the gear is a ring gear that provides rotational input into a drive axle system having at least one output axle shaft.

7. A method of reducing oil drag in a vehicle driveline component of a vehicle driveline, the vehicle driveline component having a housing defining an oil sump and a drive component rotatably supported within the housing and at least partially in the oil sump, comprising:
connecting an air pump to an air passage that is connected to a nozzle disposed in the oil sump; and
operating the air pump during vehicle driveline operation for introducing air bubbles into the oil sump directed toward the ring gear.

8. The method according to claim 7, wherein the air pump is driven by a component of the vehicle driveline.

9. The method according to claim 7, wherein the vehicle driveline component is a differential.

10. The method according to claim 7, wherein the drive component is a ring gear that provides rotational input into a drive axle system having at least one output axle shaft.
